(19) United States
(12) Patent Application Publication
(10) Pub. No.: US 2020/0067441 A1
(43) Pub. Date: Feb. 27, 2020

(54) METHOD FOR CONTROLLING THE SPEED OF A MOTOR

(71) Applicant: MOTEURS LEROY-SOMER, Angouleme Cedex 9 (FR)

(72) Inventors: Eric Coupart, Angouleme (FR); Christian Andrieux, Angouleme (FR); Michael McClelland, Champniers (FR)

(21) Appl. No.: 16/465,476

(22) PCT Filed: Dec. 6, 2017
(86) PCT No.: PCT/EP2017/081762

§ 371 Date: May 30, 2019

(30) Foreign Application Priority Data
Dec. 7, 2016 (FR) 1662067

(51) Int. Cl. H02P 25/18; H02P 23/20; H02P 25/22; F04B 49/20

(52) U.S. Cl. CPC H02P 25/188; H02P 23/20; F25B 2600/0253; F04B 49/20; H02P 25/22

(57) ABSTRACT

Method for controlling the speed of rotation of an electric motor by means of a variable speed drive supplied with power by a mains electrical power supply, in which method in a variable speed mode of operation the motor is supplied with power by the variable speed drive and in a fixed speed mode of operation the motor is supplied with power directly by the mains supply, and in which method before the changeover from the supply of power by the variable speed drive to the direct supply of power by the mains supply, the motor is first accelerated by the variable speed drive, the variable speed drive operating beyond its nominal current during the acceleration preceding the changeover.

### CROSS-REFERENCE TO RELATED APPLICATION

This patent application is a national stage submission of International Application No. PCT/EP2017/081762 filed on Dec. 6, 2017, which claims the benefit of French Application No. 1662067 filed on Dec. 7, 2016, the disclosures of which are hereby incorporated herein by reference in their respective entireties for all purposes.

### BACKGROUND

The present disclosure relates to the field of electric motors and more particularly but not exclusively that of asynchronous motors for driving compressors, pumps, fans or for the propulsion of ships. The present disclosure concerns more generally all industrial applications involving continuous processes and/or concerning the production/conversion of energy.

In installations including motors of these types speed is conventionally controlled in two ways.

The first consists in supplying power to the motor via an electronic speed controller and controlling the speed of the motor between 0 and 100% of the maximum speed by imposing the setpoint value at the input of the variable speed drive.

This solution makes it possible to save energy by modifying the speed of the motor to comply as closely as possible with the optimum conditions of operation of the installation. For example, in the case of an air compressor, fine control of the speed of the motor driving the compressor makes it possible to avoid compressing the air in a buffer tank more than necessary.

A second way is to regulate an average speed by operating on the direct supply of power to the motor from the mains supply on an on/off basis.

The advantage of this approach is to avoid the electrical losses of the variable speed drive and to increase reliability. On the other hand, this kind of control rules out operation under optimum conditions from the energy point of view.

Substantial means have been developed by businesses worldwide to improve the energy efficiency of installations utilising electric motors, notably with a view to addressing increasingly severe environmental standards and to enhance their competitiveness. Each percentage point increase in energy efficiency can lead to a substantial improvement.

U.S. Pat. No. 9,461,565 describes a system including a variable speed drive and two switches, a first of which switches is connected to the mains supply and a second of which switches is connected to the output of the variable speed drive. The motor is connected to the mains supply in a star configuration. The variable speed drive is used to start the motor and to minimise its output voltage is connected to mid-points of the windings. This makes it possible to use a less costly variable speed drive the output voltage class of which is below the nominal operating voltage of the motor.

U.S. Patent Application Publication Pub. No. 2012/0187886 describes a system including a variable speed drive and a set of contactors controlled by a control device so as to reduce the energy losses linked to the presence of the variable speed drive by supplying power to the motor directly from the mains supply if the user wishes to change from an energy saving mode in which the rotation speed to be imparted to the motor is close to that produced by supplying power to the motor directly from the mains supply. In particular, if the output frequency of the variable speed drive is substantially equal to that of the mains supply for a predefined period, the control device can automatically actuate the switches to supply power to the motor directly from the mains supply and not via the variable speed drive. A system of this kind makes controlling the motor relatively costly because the variable speed drive is rated to cause the motor to operate for long periods at the synchronous speed and because the cost of the switches and the control device is added to that of the variable speed drive.

International Publication No. WO 2015/164686 describes a device for starting an asynchronous motor in which the windings of the motor are connected in a star configuration when starting it, the speed is increased with the aid of an electronic starter (“soft starter”), and then after a certain threshold is passed the windings are disconnected and then reconnected in a triangle configuration, after which the starter is used again to accelerate the motor further. The presentation of Richard Peas, “An Overview of Medium Voltage AC Adjustable Speed Drives and IEEE Std. 1566-Standard for Performance of Adjustable Speed AC Drives Rated 375 kW and Larger” (IEEE Southern Alberta Section) discloses that for operation of an induction motor via an adjustable speed drive (ASD) the drive must be selected to allow for the starting current for the required duration of the start. This presentation shows in one slide the possibility of a direct drive by mains or through ASD depending on the state of various switches.

### SUMMARY

Examples of the disclosure provide opportunities to improve energy efficiency and increase reliability and/or longevity of variable speed drives. In one aspect, a method is provided for controlling a speed of rotation of an electric motor. The method includes supplying the electric motor with a first power from a variable speed drive when operating in a variable speed mode of operation, using the variable speed drive to accelerate the electric motor during a transition phase to a fixed speed mode of operation, and supplying the electric motor with a second power directly from the alternating current electric power supply when operating in the fixed speed mode of operation. The variable speed drive may operate beyond a nominal current during the transition phase.

In another aspect, a system is provided for controlling a speed of at least one electric motor including a plurality of windings. The system includes at least one variable speed drive coupleable to a power supply, and at least one set of switches configured to selectively supply power to the at least one electric motor from the at least one variable speed drive or directly from the power supply. The windings are in a star configuration when the power is supplied by the variable speed drive and in a triangle configuration when the power is supplied by the power supply.

In yet another aspect, an installation is provided for producing compressed air, refrigeration, ventilation, and/or pumping. The installation includes at least one motor, and a control system configured to control the motor. The control system includes a variable speed drive coupleable to a power supply, and at least one set of switches for selectively supplying power to the motor from the variable speed drive or directly from the power supply. The installation is configured to reduce a load of the motor during at least a part of a first transition phase from supplying power to the motor from the power supply to supplying power to the motor from the variable speed drive or during at least a part of a second transition phase from supplying power to the motor from the variable speed drive to supplying power to the motor from the power supply.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Examples described below will be more clearly understood when the detailed description is considered in conjunction with the accompanying drawings, in which:

FIG. 1 shows one example of a control system,

FIG. 2 shows various operations of a method of controlling the speed employing the control system shown in FIG. 1,

FIG. 3 shows an example of the operation of a control system in a constant torque application,

FIG. 4 shows an example of the trend of the current and the torque as a function of the rotation speed for one example of an 11 kW 400 V motor,

FIGS. 5 to 7 show various driven equipment,

FIG. 8 shows an example of the operation of a control system in a quadratic torque application,

FIG. 9 shows diagrammatically one example of an air compression installation with two motors,

FIGS. 10 to 12 show the air flow rate in the installation produced by a first motor, a second motor and both motors, respectively,

FIG. 13 shows one example of operating cycles of an installation on the assumption of a fixed speed motor and a variable speed motor, and

FIG. 14 shows a switch variant.

It should be noted that these drawings are intended to illustrate the general characteristics of methods, structures, and/or materials utilized in the examples and to supplement the written description provided below. These drawings are not, however, to scale and may not precisely reflect the precise structural or performance characteristics of any given example, and should not be interpreted as defining or limiting the range of values or properties encompassed by the examples.

Corresponding reference characters indicate corresponding parts throughout the drawings. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The present disclosure describes improving energy efficiency of installations utilising electric motors and increasing reliability/longevity of variable speed drives utilised without unacceptably increasing the cost of the installation. Examples described herein improve energy efficiency of installations utilising electric motors and increase reliability and/or longevity of variable speed drives utilised by controlling a speed of rotation of an electric motor (e.g., an asynchronous electric motor) by means of a variable speed drive supplied with power by a mains electrical power supply (e.g., an alternating-current electric power supply). In a variable speed mode of operation, the motor is supplied with power by the variable speed drive. In a fixed speed mode of operation, the motor is supplied with power directly by the mains supply. Before the changeover from the supply of power by the variable speed drive to the direct supply of power by the mains supply, the motor is first accelerated by the variable speed drive, the latter operating beyond its nominal current during the acceleration preceding the changeover.

By “nominal current” is meant the current for which the variable speed drive is rated for continuous operation, in other words the maximum current A_{eff} to which the variable speed drive is subjected under steady state conditions when it is driving a motor. The nominal current designates the “assigned current in continuous service” according to the EN61800-2 standard “Adjustable speed electrical power drive systems”. For example, the “nominal current”, i.e. the assigned current in continuous service, is 100 A and the overload capacity is 75% for 4 s every 240 s.

The variable speed drive is referred to as operating in dual mode.

The present disclosure offers multiple advantages.

First of all, examples described herein make it possible to combine the advantages of variable speed drive with those of supplying power directly from the mains supply.

At low speeds, the speed of the motor can be controlled precisely using a variable speed drive, for example as a function of a torque or speed setpoint received by the variable speed drive, to optimise the operating conditions of the installation that includes the motor.

For example, if the motor drives an air compressor, the pressure of the air in a buffer tank can be controlled more precisely and compressing the air more than necessary can be avoided.

At the maximum speed, the variable speed drive is no longer used and the energy losses linked to the variable speed drive are avoided, likewise other disadvantages such as generation of harmonics and wear of the variable speed drive.

Accelerating the motor by means of the variable speed drive before switching to the mains supply makes it possible to reduce the amplitude of the inrush of current on switching from supplying power via the variable speed drive to supplying power directly from the mains supply. This acceleration preferably brings the motor to its nominal speed set by the mains supply (referred to as the synchronous speed) or to a value close to this, notably to at least 0.8 Vₙ, better at least 0.9 Vₙ, even better at least 0.95 Vₙ, where Vₙ designates the nominal speed, before switching to the supply of power to the motor from the mains supply. The motor can therefore be accelerated by the variable speed drive up to a speed less than its nominal speed or up to its nominal speed.

The reduction of the current inrush on the transition from supplying power via the variable speed drive to supplying power from the mains supply makes it possible to limit the current in the switches used for this purpose (also referred to as contactors). The latter therefore do not need to be rated higher than necessary.

The variable speed drive operating beyond its nominal current during the acceleration preceding switching, for example at more than 1.5 times its nominal current, the transient overcurrent capacity of the variable speed drive is used, enabling it to function for short periods at a power greater than its nominal power. This makes it possible to utilise a variable speed drive that is less powerful than would be necessary to cause the motor to run continuously at its synchronous speed. The variable speed drive being less powerful, it is less costly, and the saving on the cost of the variable speed drive compensates the additional cost linked to the presence of the switches. The variable speed drive may operate beyond its nominal current at least when the switching occurs and preferably at least when the speed is at least 50%, 60%, 70%, 80% or 90% of the speed where the switching occurs.

The variable speed drive operates at between 130 and 170% of its nominal current during the acceleration preceding switching, for example. So-called “heavy duty” variable speed drives commercially available can generally accept an overload of more than 150% for around 10 seconds. Examples described herein subject the variable speed drive to an overload only during the period of acceleration of the motor, which is typically much less than 10 s, for example of the order of 2 to 3 s, with the result that a variable speed drive of this kind is entirely able to function in accordance with this type of operation.

There may notably be used a variable speed drive supplying 100% of its capacity in continuous service whereas the power supplied to the motor under these conditions represents only a fraction of what is supplied to it by supplying it with power directly from the mains supply. For example, at 100% of its continuous service capacity the variable speed drive supplies only 50-80% of the total power that the motor receives when it is supplied with power directly by the mains supply and is under load.

Another advantage of the examples described herein is to increase the reliability of the variable speed drive because its load is reduced since it is not used to drive the motor at the synchronous speed imposed by the mains supply.

It is preferable if in the variable speed mode of operation the motor is supplied with power by the variable speed drive in a star configuration and in the fixed speed mode of operation the motor is supplied with power directly by the mains supply in a triangle (delta) configuration. A change of configuration of this kind is preferable if the motor is operating at constant torque to drive a screw compressor for example. Alternatively, the configuration of the motor is not modified on switching from supplying power via the variable speed drive to supplying power directly from the mains supply and continues to be star-connected or triangle-connected, for example.

The star/triangle change of configuration makes it possible to have the benefit of the most beneficial configuration for each way of supplying power, via the variable speed drive or directly from the mains supply, notably in the case of a constant torque application such as driving a screw compressor to supply compressed air or a refrigeration installation, as indicated above.

In particular, the star configuration makes it possible to use a maximum output power of the variable speed drive because the power supplied is linked to the current-voltage product. On the one hand the variable speed drive operates at its maximum current and on the other hand the motor demands a high voltage thanks to its star connection.

The speed variation range when the motor is star-connected is for example between 20 and 60% inclusive of the nominal speed of the motor for so-called constant torque applications, such as driving screw compressors or positive displacement pumps, and between 40% and 85% inclusive, for example, of the nominal speed for so-called quadratic torque applications, such as driving centrifugal fans and pumps.

In the case of a quadratic torque application, the variable speed range is for example between 40 and 85% inclusive of the nominal speed as indicated above. Between 58 and 85% speed, for example, the motor operates with a level of flux below the nominal flux, for example at constant voltage and variable frequency.

The star/triangle configuration change is easy to implement because it does not impose any modifications in the manufacture of the motor, most industrial motors allowing star or triangle connection and most variable speed drives being programmable, with the result that the controller for the switches can easily be implemented without modifying the hardware of the variable speed drive.

The change from the operating mode at variable speed to that at fixed speed may be effected automatically when a setpoint value of a control parameter crosses a given threshold.

That control parameter may be the power to be supplied by the controller to the motor or a parameter representative of that power. Said threshold value is for example more than 75% of the nominal power.

The control parameter may be the rotation speed of the motor or a parameter representative of that speed. Said threshold may then have a value of more than 85% of the maximum speed, for example.

The setpoint value may depend on a magnitude representative of energy accumulated by an installation to which the motor supplies mechanical energy.

The change from the mode of operation at variable speed to that at fixed speed can be facilitated by operating on the installation to reduce temporarily the load imposed by the driven equipment for the time taken to accelerate the motor.

Accordingly, during at least part of the phase of acceleration of the motor the load on it is reduced.

For example, in the case of a compressor, an inlet valve is operated to reduce the load of the compressor; in the case of driving a variable pitch screw, the pitch of the screw is modified to reduce the torque; in the case of a pump, recirculation is allowed by opening a bypass between the inlet and the outlet of the pump.

Reducing the load makes it possible to use the overcurrent capacity of the variable speed drive required to bring the motor as close as possible to its synchronous speed, or even to the synchronous speed. The current inrush is reduced when the changeover to the mains supply occurs with the motor already at its synchronous speed.

The change from a mode of operation in which the motor is supplied with power directly by the mains supply to a mode of operation in which the motor is supplied with power via the variable speed drive may be effected via an intermediate state, preferably of short duration, in which the motor is not supplied with power either by the mains supply or by the variable speed drive.

This intermediate state causes the motor to slow down to a speed that may be zero. However, in some applications, it is preferable for the variable speed drive to “take over on the fly”, i.e. to resume the supply of power to the motor before the latter speed has fallen back to zero, the motor continuing to turn because of its inertia. Taking over on the fly corresponds to a sequence which the variable speed drive takes over supplying power to the motor cleanly, i.e. with no current peak, after detecting the frequency and the phase of the remnant voltages of the motor.

To this end, the installation may temporarily reduce the load of the driven equipment, and therefore that of the motor, for the time taken to switch to supplying power via the variable speed drive.

Accordingly, during the transition to supplying power via the variable speed drive, the load of the motor is reduced to slow its deceleration.

For example, as indicated above, in the case of a compressor, an inlet valve may be operated to reduce the load of the compressor; in the case of driving a variable pitch screw, the pitch of the screw may be varied to reduce the torque; in the case of a pump, recirculation may be allowed by opening a bypass between the inlet and the outlet of the pump. The load of the motor being reduced, the speed of the motor decreases more slowly because of its inertia and that of the driven equipment and this avoids the addition of costly electrical components such as inductors.

The inertia of the motor or of the driven equipment may be increased for this purpose, for example by adding a flywheel, so as to reduce the deceleration on disconnecting the mains supply. In the case of a fan, the inherent inertia of the fan may prove sufficient to take over on the fly without adding a flywheel.

When the direct supply of power by the mains supply ceases, the speed of the motor preferably does not decrease more than 20% in 100 milliseconds (ms), better more than 5% in 100 ms.

The motor advantageously drives a compressor, a pump or a fan, and more generally preferably drives any installation accommodating on/off type control, thanks to a mechanical or thermal inertia depending on the application. Alternatively, the motor drives a propeller shaft of a ship.

The motor is for example supplied with power by the mains supply between 10 and 50% of its operating time. For the rest of its operating time it is supplied with power via the variable speed drive.

The variable speed drive may be a passive rectifier (e.g., thyristor or diode bridge) variable speed drive or alternatively an active component (e.g., IGBT type) variable speed drive.

According to another of its aspects, examples described herein further include a method for controlling the operation of an installation including at least one electric motor supplying mechanical energy to said installation, in which method the speed of the motor is controlled as a function of a requirement of the installation for energy produced by the motor by the method as defined above.

The installation may include at least two systems operating in parallel, each including a motor controlled in dual mode in accordance with examples described herein, the motors combining their effects to address the requirement for production of energy for the installation. Each motor can then be controlled as a function of the requirement of the installation, one of the motors being driven at variable speed while the other is stopped when the requirement of the installation for energy produced by the motors is low and one of the motors being supplied with power at fixed speed directly by the mains supply and the other at variable speed by one of the variable speed drives when the requirement of the installation to be supplied with mechanical energy is higher.

The use of two variable speed drives operating in dual mode enables fine control of the energy produced by the motors over a wider range of power than control at variable speed using a single variable speed drive operating in dual mode.

The variable speed drives may exchange between them information for controlling the respective powers and the corresponding sets of switches, one functioning as master and the other as slave, for example.

A relatively high energy saving is more particularly obtained when the requirement of the installation to be supplied with mechanical energy by the motor or motors at maximum power represents between 10% and 75% of the total duration of use of the installation, better between 10 and 50%.

The supply of mechanical energy by the motors may serve for the production of compressed air or for refrigeration. Alternatively, the installation is a ventilation installation, for example for a tunnel, or includes cascaded pumping systems.

It may prove advantageous to vary the chopping frequency of the variable speed drive according to whether the latter functions in continuous service in the variable speed operating mode without exceeding its nominal power or during the acceleration preceding switching the motor to be supplied with power by the mains supply.

As a general rule, decreasing the chopping frequency increases the losses of the motor.

Nevertheless, a lower chopping frequency can be tolerated during the acceleration phase because it is of short duration and the corresponding electrical losses are negligible.

Accordingly, the method may include the operation of reducing the chopping frequency of the variable speed drive during the acceleration of the motor preceding the switching of the power supply of the latter to direct supply of power by the mains supply.

If f_{ds} designates the chopping frequency of the variable speed drive in continuous service and f_{da} the chopping frequency during the acceleration preceding switching, then f_{ds}/f_{da} may be between 1.2 and 3.5, better between 1.5 and 2.5. For example f_{ds} is close to 3 kHz and f_{da} of the order of 1.5 kHz.

Decreasing the chopping frequency makes it possible to increase the current available at the output of the variable speed drive, which can facilitate the acceleration of the motor and therefore reduce the duration of the transient period between control at variable speed and power supply by the mains supply at fixed speed.

During the transient phase of acceleration of the motor by the variable speed drive to reach the nominal speed or a speed close to the latter the modulation may be of pulse width modulation or other type.

The examples described herein moreover make it possible to use a motor optimised for operation with a variable speed drive despite the direct supply of power by the mains supply. A motor optimised for operation with a variable speed drive is a motor that cannot be connected directly to the mains supply to start it because of the high current inrush that it generates on starting.

Bringing a motor of this kind to its synchronous speed or to a speed close to the latter by means of the variable speed drive makes it possible to limit the current inrush on switching it to supply of power by the mains supply and makes possible direct supply of power to it by the mains supply. This can make it possible to use a motor of simpler design and or higher efficiency.

According to another of its aspects, independently of or in combination with the preceding aspects, the examples described herein include a method for controlling the rotation speed of an electric motor, notably an asynchronous electric motor, using a variable speed drive supplied with power by a mains electrical power supply in which in a mode of operation at variable speed the motor is supplied with power by the variable speed drive in a star configuration and in a mode of operation at fixed speed the motor is supplied with power directly by the mains supply in a triangle configuration.

According to another of its aspects, the examples described herein further include in a system for controlling the speed of at least one electric motor, notably an asynchronous electric motor, in particular using a method according to the examples described herein as defined above, including:
at least one variable speed drive to be connected to a mains electrical power supply, and notably with a nominal current insufficient to drive the motor under load in continuous service at its synchronous speed,
at least one set of switches for selectively supplying power to the motor via the variable speed drive or directly from the mains supply and preferably also making it possible to switch the windings of the motor between a star configuration when supplied with power via the variable speed drive and a triangle configuration when supplied with power by the mains supply.

The variable speed drive can be adapted to operate on the switches automatically to change from direct supply of power by the mains supply if a setpoint value of a control parameter exceeds a predefined threshold. The control parameter may be as defined above, for example the power to be supplied by the controller to the motor or a parameter representative of that power.

The variable speed drive may be adapted to accelerate the motor automatically beyond said threshold, preferably up to a speed close to the synchronous speed, before switching the supply of power to the motor directly from the mains supply.

The variable speed drive has a nominal current insufficient to operate the motor at its synchronous speed over a long period, i.e. in continuous service, when it is driving the equipment normally, i.e. when it is loaded. For example, the nominal power of the variable speed drive driving the motor corresponds to less than 70% of the nominal power of the motor when it is supplied with power directly by the mains supply.

The system may include two motors adding their effects to address a mechanical energy requirement of the installation, each motor being connected to a variable speed drive connected to a mains electrical power supply and to a set of switches for selectively supplying power to the motor via the variable speed drive or direct from the mains supply, and preferably switching the windings of the motor between a star configuration when supplied with power via the variable speed drive and a triangle configuration when supplied with power by the mains supply, the variable speed drives and the sets of switches being controlled so that one of the motors is driven at variable speed whereas the other is stopped when the requirement of the installation for energy produced by the motors is low and one of the motors is supplied with power directly by the mains supply and the other via one of the variable speed drives when the requirement of the installation for energy produced by the motors is higher, and then for both motors to be supplied with power by the mains supply when the requirement reaches a maximum.

The examples described herein further include, independently of or in combination with the foregoing, in a method of controlling the operation of an installation, notably for the production of compressed air, refrigeration, ventilation or pumping, including at least two motors adding their effects to address a requirement of the installation for production of mechanical energy, said motors being supplied with power by respective variable speed drives, notably at least two variable speed drives of control systems as defined above, in which the requirement of the installation for the production of mechanical energy is controlled by giving preference to the operation of one or other of the variable speed drives so as substantially to equalise their times of operation, for example with a relative difference |nₘₐₓ−nₘᵢₙ|/nₘᵢₙ of less than 20%, where nₘₐₓ is the maximum number of hours of operation of one of the variable speed drives and nₘᵢₙ is the number of hours of operation of the other variable speed drive.

It is thus possible to benefit from a maintenance operation taking place when one variable speed drive reaches a predetermined number of hours of operation to carry out the maintenance of the other variable speed drive or drives having almost the same number of hours of operation. This therefore reduces the cost and the inconvenience arising from maintenance by reducing over time the number of visits for maintenance operations.

The examples described herein further include, independently of or in combination with the foregoing, in a method for saving energy and/or increasing the reliability of at least one variable speed drive driving an electric motor, notably an asynchronous electric motor, in which the variable speed drive has insufficient power to drive the motor at its synchronous speed in continuous service and in which the variable speed drive is used for only part of the total time of operation of the motor, notably between 40 and 75% inclusive of the total time of operation, and the motor is supplied with power directly by the mains supply for the remaining time, and in which the configuration of the windings of the motor between the supply of power directly by the mains supply and the supply of power via the variable speed drive is preferably modified automatically according to whether the motor is supplied with power directly or via the variable speed drive.

The examples described herein further include, independently of or in combination with the foregoing, in an installation, notably for the production of compressed air, refrigeration, ventilation or pumping, including at least one motor and a corresponding control system including a variable speed drive to be connected to a mains electrical power supply and at least one set of switches for selectively supplying the motor with power via the variable speed drive or directly from the mains supply, the installation being adapted to reduce the load of the motor during at least part of the duration of the transient phase from direct supply of power by the mains supply to supply of power via the variable speed drive and/or at least a part of the transition phase from supply of power via the variable speed drive to direct supply of power by the mains supply.

For example, the installation includes a compressor driven by the motor, provided with an inlet valve, the control system being adapted to operate the inlet valve to reduce the load of the motor during said transition phase.

Alternatively, the installation includes a pump driven by the motor, provided with a bypass valve, the control system being adapted to operate the bypass valve in order to reduce the load of the motor during said transition phase.

Other features and advantages of the present disclosure will emerge on reading the following detailed description of non-limiting embodiments of the examples described herein and examining the appended drawings.

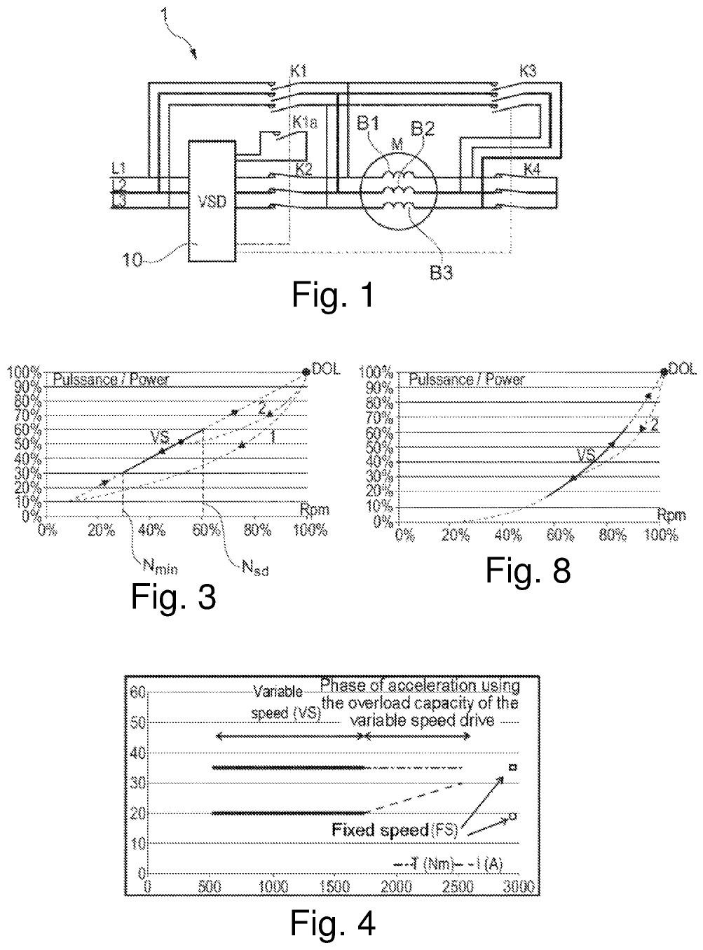

FIG. 1 shows one example of a control system 1. The control system 1 is connected to a 400 V 50 Hz or 60 Hz three-phase mains supply L1, L2, L3 for example and to a three-phase asynchronous electric motor M including three motor windings B1, B2 and B3.

The motor M is for example a compressor motor having to operate at variable speed in a compressed air production unit, but the examples described herein are not limited to that particular application.

The system 1 includes a variable frequency variable speed drive (VSD) 10 with its input connected to the mains supply L1, L2 and L3.

This variable speed drive 10 is for controlling four switches K1, K2, K3 and K4 which are electromechanical relays in the example described but could alternatively be semiconductor switches. These switches may be connected directly to appropriate voltage outputs of the variable speed drive, for example 12 V, 24 V, 48 V, 110 V or 230 V, or alternatively a power interface module is provided between the variable speed drive and the switches to supply power to the latter.

The input of the switch K1 is connected to the three phases L1, L2 and L3 of the mains supply and its output is connected to the three phases U, V and W of the motor M downstream of the switch K2.

The input of the switch K2 is connected to the output of the variable speed drive 10 and its output is connected to the three phases U, V and W of the motor M. In a variant, the switch K2 is omitted.

The switches K3 and K4 are utilised to switch the windings B1, B2 and B3 of the motor from a star configuration (termed a “Y” configuration) to a triangle configuration (termed a “delta” configuration), and vice versa. The switches K3 and K4 are preferably mechanically connected to prevent short circuits. Thus K3 and K4 are mechanically forced to change state simultaneously. The switch K4 is preferably a three-phase switch but may alternatively be a two-phase switch. Status indicator lamps may be provided if necessary. A contact K1a may be provided on the switch K1 to advise the variable speed drive 10 of its open state, which can be useful in a takeover on the fly application as is explained hereinafter.

The variable speed drive may be disposed in a control cabinet placed in the vicinity of the motor or disposed elsewhere. The variable speed drive 10 preferably includes a single module that contains all of its electronics. Alternatively, the variable speed drive includes a main module corresponding to a standard variable speed drive and an auxiliary module that provides the functions according to examples of power supply to and or control of the switches, this auxiliary module being connected to the main module by any cable or other connection enabling the exchange of information. The switches are preferably grouped together in the same cabinet or module and where applicable are disposed in the aforementioned auxiliary module. If necessary, the variable speed drive may be received in a module fixed directly to the frame of the motor.

The variable speed drive 10 receives a setpoint for a control parameter, for example a setpoint speed or a magnitude representative of the power to be supplied to the motor by the variable speed drive, which is supplied to it for example by an automatic controller of the installation including the compressor, as a function of the status of one or more pressure or other sensors or by another variable speed drive functioning as the master.

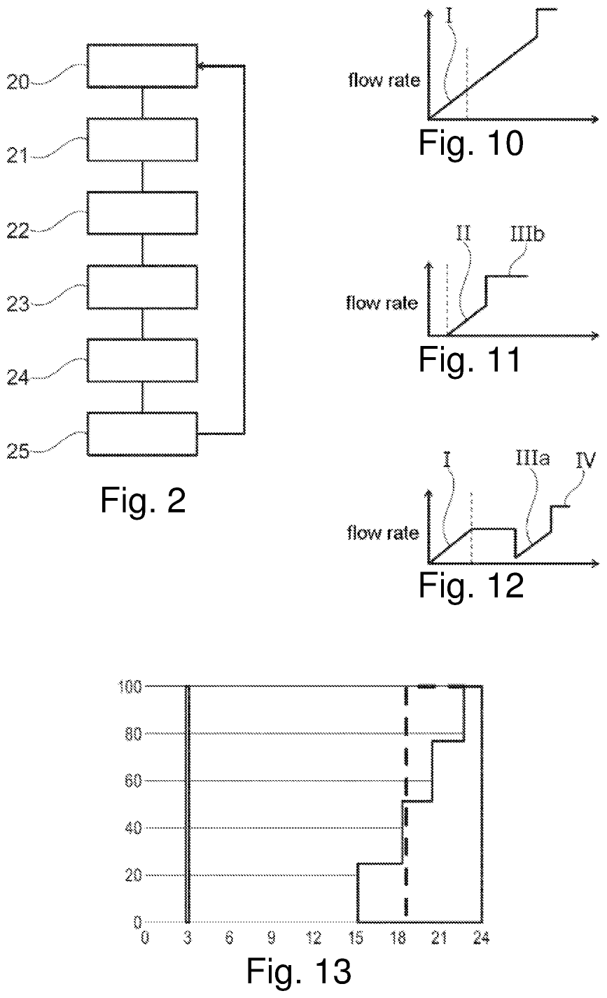

FIG. 2 shows example operations 20-25 of the control system 1.

On starting up, in the operation 20, the contactor K1 is open, the contactor K2 closed, the contactor K3 open and the contactor K4 closed with the result that the motor M is supplied with power by the variable speed drive 10 with the windings B1, B2 and B3 in a star configuration.

The speed of the motor is controlled in the operation 21 by means of the variable speed drive 10 operating in continuous service mode provided that the speed corresponding to the setpoint remains supply in a range Nₘᵢₙ to N_{sd} that enables the air flow rate in the compressor to be adjusted between values d1 and d2. For example Nₘᵢₙ is equal to 16 Hz and N_{sd} equal to 30 Hz. The power evolves within a certain range, as shown in FIG. 3, without the current from the variable speed drive exceeding the nominal current. This is referred to as operation at variable speed (VS).

Control may be effected within this range at substantially constant motor torque, as shown in FIG. 4, with a substantially constant motor current.

If the flow rate requirement exceeds the limit d2 and a corresponding setpoint is sent to the variable speed drive, for example by the aforementioned automatic controller, then the system 1 goes to a mode of operation aimed at dispensing with the variable speed drive 10.

To this end in the operation 22 the variable speed drive 10 initially accelerates the motor M to a speed close to its synchronous speed.

During this acceleration, the variable speed drive 10 preferably maintains a constant voltage but increases the current, as shown in FIG. 4. This exploits the ability of the variable speed drive 10 to operate with an overcurrent for a short period. The torque may be maintained constant when the motor drives a screw compressor; it may be variable in other applications, for example for driving a centrifugal pump or a fan.

To accelerate the motor M to a speed close to its synchronous speed, there is exploited the ability of the variable speed drive to operate at up to 150% of its nominal current, for example, for the short time period required for the acceleration. During the acceleration phase, the motor remains supply in its star configuration.

Once a transition speed has been reached, for example of the order of 2500 rpm or more in the example considered here, the variable speed drive 10 deactivates its output stage and then operates the various switches to cause the motor to operate at a fixed speed and to be supplied with power directly by the mains supply. This is referred to as DOL (“Direct On Line”) mode.

Accordingly, in the operation 23, the switch K1 closes and the switch K2 simultaneously opens.

The switches K3 and K4 are preferably mechanically connected to each other, as mentioned above. The switch K4 opens, the switch K3 closes, and the windings of the motor are connected in accordance with a triangle configuration.

The variable speed drive 10 is inactive and the motor is supplied with power directly by the mains supply. It completes its acceleration if necessary to reach its synchronous speed, here 3000 rpm for a 50 Hz mains supply, as shown in FIG. 4.

The direct supply of power to the motor by the mains supply is maintained during the operation 24 for as long as the requirement for full speed is present.

If the setpoint sent to the variable speed drive 10 in the operation 25, for example by the aforementioned automatic controller, corresponds to a speed between Nₘᵢₙ and N_{sd}, then the control system reverts to the VS configuration of the operation 20, the speed of the motor M being for example first reduced to zero as shown by the line 1 in FIG. 3 for a constant torque application.

For some applications, the installation may advantageously be configured to reduce the load of the motor at the moment of the transition to the mains supply, so as to enable the motor to accelerate more easily, and notably to enable the variable speed drive to accelerate the motor up to its nominal speed while operating with an overcurrent.

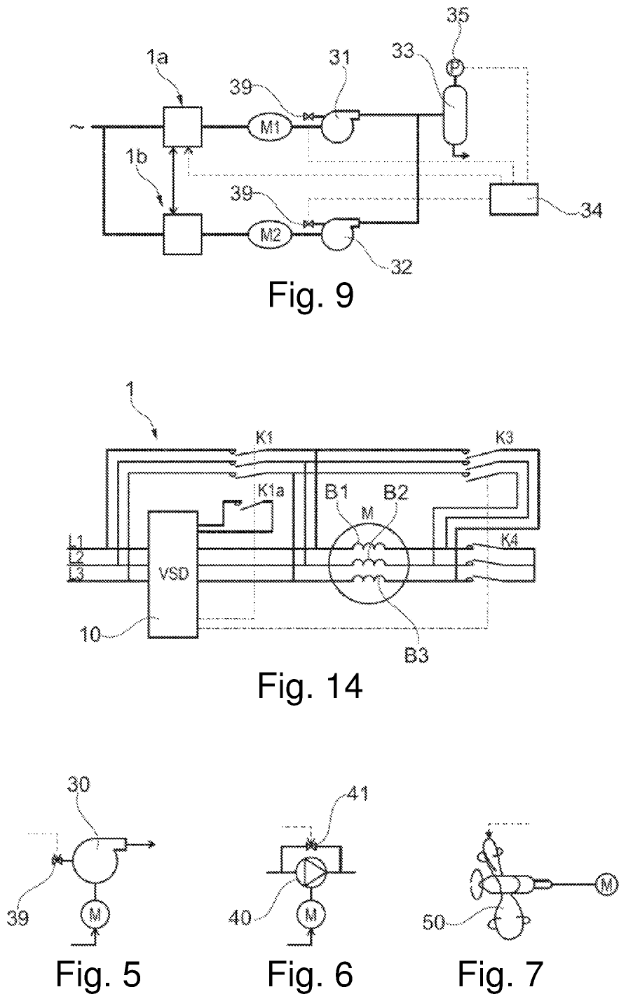

For example, if the equipment driven by the motor M is an air compressor 30, as shown in FIG. 5, an air inlet valve 39 can be operated to close it so that the compressor then operates off load at reduced load. This valve is then opened once the motor is connected directly to the mains supply, to resume normal operation.

If the driven equipment is a pump 40, as shown in FIG. 6, a bypass valve 41 may be operated in order to reduce the load of the pump.

If the driven equipment is a variable pitch screw 50, as shown in FIG. 7, the pitch of the screw may be reduced in order to reduce the torque.

Where appropriate, the action on the equipment to reduce the load is begun when the variable speed drive has not yet begun to accelerate the motor, so as to allow for the time necessary for the load actually to be reduced. Alternatively, the acceleration of the motor by means of the variable speed drive is begun, after which the load-shedding is effected with the acceleration in progress, to assist the variable speed drive to bring the motor to a speed as close as possible to the synchronous speed. This can make it possible to reduce the load-shedding time.

Similarly, it may prove advantageous in some applications for the installation to be configured to slow the deceleration of the motor during the transition to the supply of power by the variable speed drive in order to enable taking over on the fly without adding costly additional electronic components such as inductors. The line 2 in FIG. 2 shows taking over on the fly in this way in the case of a constant torque. The line 2 in FIG. 8 shows taking over on the fly in this way in the case of a quadratic torque application.

To this end, the inertia of the motor or of the driven equipment can be increased in order to slow the deceleration. If the motor drives a fan, one possibility is to add a flywheel.

If possible, an element of the installation making it possible to reduce the load at the time of this transition may advantageously also be operated on.

It may be particularly beneficial to have the supply of power taken over again by the variable speed drive before the speed has fallen to zero for some applications such as air compressors or ventilation systems in order to prevent the equipment restarting from a zero or excessively low speed. In fact, some equipment, such as compressors, suffer much more wear if they are restarted from a zero speed because there is less lubrication at low speed.

The opening of the contact K1a informs the variable speed drive that the switch K1 is open and that the taking over on the fly can be effected.

If the driven equipment is a compressor 30, as shown in FIG. 5, when the supply of power from the mains supply ceases the air inlet valve 39 may be closed to reduce the load of the compressor and to slow the deceleration of the motor.

Once the variable speed drive has taken over the supply of power again, the valve 39 can be opened.

If the driven equipment is a pump 40, as shown in FIG. 6, the bypass valve 41 is open for the time of the transition when the variable speed drive takes over the supply of power again.

If the driven equipment is a variable pitch screw 50, for example for ship propulsion, as shown in FIG. 7, the pitch is changed to reduce the torque during the transition.

Where appropriate, the action on the equipment to reduce the load is begun when the motor is still being driven by the mains supply so as to allow for the time necessary for the load actually to decrease. It is in fact preferable to wait for the load-shedding to be effected and reduce the torque of the driven equipment before seeking to take over on the fly the supply of power by the variable speed drive.

The variable speed drive may function with a constant chopping frequency in continuous service and during the transient acceleration period preceding the changeover to the mains supply.

However, the chopping frequency of the variable speed drive is preferably reduced momentarily during the transient period so as to benefit from a higher motor torque. The chopping frequency may be reduced by half, for example. This frequency reduction may be effected automatically, by programming the variable speed drive to this end.

It may prove advantageous to provide a plurality of systems according to examples described herein in parallel functioning in dual mode.

FIG. 9 shows by way of example a compressed air production installation including two motors M1 and M2 driving respective compressors 31 and 32 connected to a compressed air buffer tank 33.

Each motor M1 or M2 is connected to a respective control system 1a or 1b according to the examples described herein including a variable speed drive and a set of switches K1 to K4 as described above.

The installation may include an automatic controller 34 that controls its operation, for example as a function of information from various sensors, for example at least one sensor 35 giving the pressure in the buffer tank 33, as shown.

The automatic controller 34 is for example connected to the control input on the variable speed drive of the control system 1a whereas the variable speed drive of the other control system 1b functions in slave mode, its operation being controlled by the variable speed drive of the control system 1a. Alternatively, the variable speed drives of the control systems 1a and 1b both receive a signal from the automatic controller 34 on a corresponding control input. As shown, the automatic controller may control inlet valves 39 for load-shedding on the compressors 31 and 32 during the transitions, as explained above.

Control may be effected in the following manner.

If the air flow requirement is relatively low, only the motor M1 is supplied with power at variable speed to produce the required flow rate, as shown in FIGS. 10 to 12. The motor M2 is not supplied with power. This situation corresponds to the segment I in FIGS. 10 and 12.

If the flow rate requirement increases, the second motor M2 can start, being supplied with power by the variable speed drive in the control system 1b at variable speed. This corresponds to the segment II in FIG. 11. During the increase in the speed of the motor M2, the speed of the motor M1 may remain constant, the motor M1 continuing to be supplied with power by the variable speed drive.

The advantage of operating both variable speed drives rather than only one at higher power is to render uniform the period of operation of the variable speed drives and therefore to avoid having to schedule two successive maintenance operations each specific to one of the variable speed drives; if the operating times of the variable speed drives are similar, they can be serviced during the same maintenance operation. This avoids multiple visits by the maintenance technician.

If the flow rate requirement increases further, the control system 1b can switch to DOL mode, which is shown by the segment IIIb, whereas the control system 1a remains supply in VS mode, which corresponds to the segment IIIa. The power supplied to the motor by the control system 1a is nevertheless reduced if the aim is to provide a linear increase in the flow rate, as shown.

If the flow rate requirement is at the maximum, then the control system 1a also switches to DOL mode, which corresponds to the segment IV.

Energy saving calculation example

There is plotted on the ordinate axis in FIG. 13 the percentage power supplied by a motor driving an air compressor of an installation having a compressed air requirement and on the abscissa axis the daily period of use of the installation each day of the week. The installation is active (“open”) in this example only between 03:00 h and 24:00 h.

It is assumed here that to meet the compressed air requirement the motor is caused to operate at fixed speed directly from the mains supply during a period corresponding to 28% of the period during which the installation is active. This is represented by a dashed line rectangle in FIG. 13.

The equivalent control profile of the motor is then determined in the case of operation at variable speed to produce the same quantity of compressed air at the required pressure. A stepped progression is chosen, for example, with steps at 25%, 45%, 75% and 100%.

The necessary electrical energy consumption in the various situations is then calculated together with the electrical power consumption taking as reference an IE2 IM class motor driven at fixed speed directly by the mains supply.

Table 1 below gives the respective savings.

TABLE 1

| | |
|---|---|
| IE3 IM fixed speed (prior art) | 1.7% |
| IE4 IM fixed speed (prior art) | 3.1% |
| IE2 IM variable speed (prior art) | 8.9% |
| IE3 IM variable speed (prior art) | 10.5% |
| IE4 IM variable speed (prior art) | 11.8% |
| IE5 IM variable speed (prior art) | 12.7% |
| IE2 IM dual mode (invention) | 9.7% |
| IE3 IM dual mode (invention) | 11.3% |
| IE4 IM dual mode (invention) | 12.5% |
| IE5 IM dual mode (invention) | 13.5% |

It is seen that supplying power to the motor at variable speed achieves a non-negligible saving compared to driving at fixed speed.

It is also seen that the examples described herein make it possible to obtain better energy efficiency from the installation, which can make it possible, for a similar energy efficiency, to reduce the class of the motor and therefore to use a less costly motor.

The above calculation may be repeated for 43% and 60% activity of the installation, for example. In both cases there is found a non-negligible saving relating to the energy efficiency of the installation, introduced by the examples described herein, of up to 8.7% for example for a rate of 43% and an IE3 IM class motor, which is a value comparable to that obtained of 8.8% in operation at variable speed with a higher class IE4 IM motor that is more costly.

This can be taken as far as either using an IE5 IM class motor or using an IE4 class motor with substantially the same saving as a more costly IE5 class motor.

Of course, aspects and advantages of the present disclosure are not limited to the examples that have just been described.

For example, the frequency values between which control is effected by means of the variable speed drive can be modified as a function of the application or of the polarity of the motor M, among other things.

The switches may be based on semiconductors. In the variant shown in FIG. 14, the contactor K4 is a two-phase contactor, one of the phases being permanently connected.

In some applications, such as quadratic torque applications, the configuration of the windings may remain unchanged, for example remaining at star or triangle.

The examples described herein are not limited only to the applications described and may be applied to other fields involving production/conversion of energy and/or to other continuous processes.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. The terms “comprising,” “including,” and “having” are intended to be inclusive and mean that there may be elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-43. (canceled)

44. A method of controlling a speed of rotation of an electric motor, the method comprising:
supplying the electric motor with a first power from a variable speed drive when operating in a variable speed mode of operation, the variable speed drive powered by an alternating current electric power supply;
using the variable speed drive to accelerate the electric motor during a transition phase to a fixed speed mode of operation, the variable speed drive operating beyond a nominal current during the transition phase; and
supplying the electric motor with a second power directly from the alternating current electric power supply when operating in the fixed speed mode of operation.

45. The method according to claim 44, in which, in the variable speed mode of operation, the variable speed drive is in a star configuration, and, in the fixed speed mode of operation, the alternating current electric power supply is in a triangle configuration.

46. The method according to claim 44, wherein the transition phase is effected automatically when a setpoint value of a control parameter crosses a given threshold.

47. The method according to claim 46, wherein the control parameter is one of a torque or a parameter representative of the first power to be supplied to the electric motor from the variable speed drive, and the given threshold is a value at least 75% of a nominal power.

48. The method according to claim 46, wherein the control parameter is one of a speed of rotation of the electric motor or a parameter representative of the speed of rotation of the electric motor, and the given threshold is a value at least 60% of a nominal speed.

49. The method according to claim 44, in which a chopping frequency of the variable speed drive is reduced during the transition phase.

50. The method according to claim 44. wherein the variable speed drive operates at between approximately 130% and approximately 170% of the nominal current during the transition phase.

51. The method according to claim 44, further comprising reducing a load of the electric motor during at least a part of the transition phase by operating one or more of an inlet valve of a compressor, a bypass valve of a pump, or a pitch of a variable pitch screw.

52. The method according to claim 44, further comprising ceasing to supply the electric motor with the second power to decelerate the electric motor during an intermediate state when changing from the fixed speed mode of operation to the variable speed mode of operation.

53. The method according to claim 52, further comprising reducing a load of the electric motor during at least a part of the intermediate state by operating one or more of an inlet valve of a compressor, a bypass valve of a pump, or a pitch of a variable pitch screw.

54. A system for controlling a speed of at least one electric motor including a plurality of windings, the system including:
at least one variable speed drive coupleable to a power supply; and
at least one set of switches configured to selectively supply power to the at least one electric motor from the at least one variable speed drive or directly from the power supply, wherein the plurality of windings are in a star configuration when the power is supplied by the variable speed drive and in a triangle configuration when the power is supplied by the power supply.

55. The system according to claim 54, the at least one set of switches are configured to automatically supply power directly from the power supply when a setpoint value of a control parameter exceeds a predefined threshold.

56. The system according to claim 55, wherein the control parameter is one of a torque or a parameter representative of the power supplied to the at least one electric motor by the variable speed drive, and the predefined threshold is a value at least 75% of a nominal power.

57. The system according to claim 55, wherein the control parameter is one of a speed of rotation of the at least one electric motor or a parameter representative of the speed of rotation of the at least one electric motor, and the predefined threshold is a value at least 60% of a nominal speed.

58. The system according to claim 54, further comprising a compressor including an inlet valve, wherein the inlet valve is operated to reduce a load of the at least one electric motor.

59. The system according to claim 54, further comprising a pump including a bypass valve, wherein the bypass valve is operated to reduce a load of the at least one electric motor.

60. The system according to claim 54, further comprising a variable pitch screw, wherein a pitch of the variable pitch screw is modified to reduce a load of the at least one electric motor.

61. An installation for producing one or more of compressed air, refrigeration, ventilation or pumping, the installation comprising:
at least one motor; and
a control system configured to control the at least one motor, the control system including a variable speed drive coupleable to a power supply and at least one set of switches for selectively supplying power to the at least one motor from one of the variable speed drive or directly from the power supply, the installation configured to reduce a load of the at least one motor during at least a part of a first transition phase from supplying power to the at least one motor from the power supply to supplying power to the at least one motor from the variable speed drive or at least a part of a second transition phase from supplying power to the at least one motor from the variable speed drive to supplying power to the at least one motor from the power supply.

62. The installation according to claim 61, further comprising a compressor driven by the at least one motor, the compressor including an inlet valve, the control system configured to selectively operate the inlet valve for reducing the load of the at least one motor.

63. The installation according to claim 61, further comprising a pump driven by the at least one motor, the pump including a bypass valve, the control system configured to selectively operate the bypass valve for reducing the load of the at least one motor.
